(19) United States
(12) Patent Application Publication
(10) Pub. No.: US 2014/0075502 A1
(43) Pub. Date: Mar. 13, 2014

(54) RESOURCE MANAGEMENT OF EXECUTION ENVIRONMENTS

(71) Applicants: Selim Aissi, Menlo Park, CA (US); Taeho Kgil, Foster City, CA (US)

(72) Inventors: Selim Aissi, Menlo Park, CA (US); Taeho Kgil, Foster City, CA (US)

(21) Appl. No.: 14/024,022

(22) Filed: Sep. 11, 2013

Related U.S. Application Data
(60) Provisional application No. 61/699,578, filed on Sep. 11, 2012.

(51) Int. Cl. G06F 21/60

(52) U.S. Cl. CPC G06F 21/60
USPC 726/1; 726/26

(57) ABSTRACT

Techniques for managing resources on a computing device may include a resource management module that can identify an asset available for use by the computing device. The asset can be classified based on one or more properties of the asset, and the value of the asset is determined based on the classification. The resource management module may determine that the value of the asset has changed, and the asset is ranked based on the value of the asset. The appropriate execution environment for the asset can be determined based on the ranking, and the asset can be dynamically migrated from one execution environment to another execution environment based on the dynamic value of the asset.

### CROSS-REFERENCES TO RELATED APPLICATIONS

This application is a non-provisional application and claims the benefit of priority of U.S. Provisional Application No. 61/699,578 titled “OFFLOADING WORKLOAD BASED ON CHANGING SECURITY PROFILE OF ASSETS” filed on Sep. 11, 2012, which is herein incorporated by reference in its entirety for all purposes.

### BACKGROUND

Embedded computing devices, such as computers, mobile devices, point-of-sale devices, security token devices, etc., continuously store and interact with sensitive data. Sensitive data can be stored all across the device and can be controlled and managed by multiple applications. Sensitive data also continue to funnel into the device through user input, applications, cameras, sensors, interactions with other devices, removable media or any other suitable means. As the reliance on these embedded computing devices to conduct secure transactions such as payment and banking functions increases, the amount of sensitive data that is stored and managed on the device increases. One way of protecting the sensitive data is to provide a secure execution environment for the processing and storage of such data. For example, a computing device can be equipped with a secure element in the form of a hardware chip to implement a secure execution environment for the secure storage and processing of sensitive data. However, the amount of sensitive data that can be protected by a secure element is limited by the computing resources and storage capacity of the secure element. The increase in the amount of sensitive data being managed and stored on a computing device results in the need for better resource management of the execution environments available to the computing device.

Embodiments of the invention address these and other problems, individually and collectively.

### BRIEF SUMMARY

Embodiments of the present disclosure provides techniques for managing resources on a computing device. A resource management module (e.g., running on a computing device or remotely at a trusted entity) can identify an asset that is available for use by the computing device. The asset can be classified based on one or more properties of the asset, and the value of the asset is determined based on the classification. The resource management module may determine that the value of the asset has changed, and the asset is ranked based on the value of the asset. The appropriate execution environment for the asset can be determined based on the ranking, and the asset can be dynamically migrated from one execution environment to another execution environment based on the dynamic value of the asset.

Some embodiments may provide a computing device that includes one or more processors and one or more computer readable and/or writable memories coupled to the one or more processors. The components of the computing device can be used to implement multiple execution environments that have different security profiles, and one or more resource managers or resource management modules. In some embodiments, there may be multiple resource managers or resource management modules per execution environment, and the privileges that each resource manager or resource management module manages are dependent on the privileges assigned to each execution environment. Hereinafter, the one or more resource managers or resource management modules will be referred to as a resource manager or a resource management module, but it should be understood that some embodiments may have multiples of each. The resource manager can be configured to determine the value of an asset accessible by the computing device based on the classification of the asset. The resource manager can monitor the value of the asset, and can dynamically migrate the asset from one execution environment to another execution environment in response to detecting a change in the value of the asset.

Some embodiments may provide a system that includes a computing device that is coupled to a public cloud and/or a private cloud. The public and private clouds may be used to implement addition execution environments available to the computing device. In some embodiments, the private cloud may include a remote secure execution environment providing a stringent level of security equivalent to or exceeding a secure element.

### BRIEF DESCRIPTION OF THE DRAWINGS

FIG. 1 illustrates an exemplary system that can be used to implement the resource management techniques in accordance with some embodiments of the invention.

FIG. 2 illustrates a diagram of an exemplary ranking of assets to various execution environments in accordance with some embodiments of the invention.

FIG. 3 illustrates a diagram of another exemplary ranking of assets to various execution environments in accordance with some embodiments of the invention.

FIG. 4A illustrates a block diagram of an exemplary computing device mapping an asset to an execution environment in accordance with some embodiments of the invention.

FIG. 4B illustrates a block diagram of an exemplary computing device migrating an asset to an execution environment in accordance with some embodiments of the invention.

FIG. 4C illustrates a block diagram of an exemplary computing device migrating an asset to another execution environment in accordance with some embodiments of the invention.

FIG. 4D illustrates a block diagram of an exemplary computing device migrating an asset to a further execution environment in accordance with some embodiments of the invention.

FIG. 5 illustrates an exemplary flow diagram for managing resources available to a computing device in accordance with some embodiments of the invention.

FIG. 6 illustrates an exemplary flow diagram for migrating an asset to an execution environment in accordance with some embodiments of the invention.

FIG. 7 illustrates a block diagram of an exemplary mobile device in accordance with some embodiments of the invention.

FIG. 8 illustrates a block diagram of an exemplary computing device in accordance with some embodiments of the invention.

### DETAILED DESCRIPTION

Embodiments of the present disclosure are directed to systems and methods for resource management on a computing device by shifting the maintenance, management, execution, and/or storage of an asset to an execution environment based on the dynamic security requirement of the asset. Assets available to a computing device are classified according to the type of the asset, and the dynamic value of each asset is determined based on the classification. The asset can be ranked using temporal thresholds and the dynamic value associated with each asset, and the assets are migrated accordingly to different execution environments based on the ranking.

Examples of execution environments available to a computing device according to various embodiments may include a secure element (SE) and/or a private cloud implemented an equivalent or higher security environment, a trusted execution environment (TEE), an operating system (OS) environment, a software application environment, and a public cloud, etc. Each execution environment has certain resources implemented in hardware and/or software available for the management, storage, and/or execution of assets operating in the particular environment. In some embodiments, only the tasks (e.g., maintenance, management, execution, and/or storage) involving highly sensitive or sensitive assets are mapped onto SE/TEE environments due to the limited resources associated with those environments. As the value of an asset changes over time, the tasks associated with the asset may be deprecated to an execution environment with a lower security profile. Offloading the workload of tasks involving an asset to an appropriate execution environment provides for efficient resource management without requiring additional processing power or storage capacity in the computing device. When the asset becomes highly valuable, the tasks associated with the asset can be remapped onto SE/TEE environments to ensure proper security protection is provided to the asset.

Prior to discussing the various embodiments of the present invention, a description of some terms may be helpful for a better understanding of the disclosure.

As used herein, a “computing device” is a device that includes electronic components such as one or more processors coupled to one or more computer readable and/or writable memories (e.g., implementing one or more storage devices and/or system memories). A computing device can be used to execute one or more software applications. A computing device may also implement multiple execution environments using hardware, software, or a combination of both for managing, processing, and/or storage of assets. Examples of computing devices may include computers, mobile devices, point-of-sale devices, security token devices, etc. Some computing devices such as point-of-sale devices and security token devices are specialized for conducting financial transactions.

As used herein, a “mobile device” is an electronic device that may be transported and operated by a user, which may also provide remote communication capabilities to a network. The mobile device may be configured to transmit and receive messages or communications to and from other computing devices, and display messages on a display screen on the mobile device. Examples of mobile devices include mobile phones (e.g. smart phones, cellular phones, etc.), PDAs, tablet computers, netbooks, laptop computers, personal music players, hand-held specialized readers, etc.

As used herein, a “server” or “server computer” may typically be a powerful computer or cluster of computers. For example, the server computer can be a large mainframe, a minicomputer cluster, or a group of servers functioning as a unit. In one example, the server computer may be a database server coupled to a web server.

As used herein, a “cloud” is a remote computing resource accessible by a computing device that can assist the computing device with managing, processing, and/or storage of assets. A cloud can be implemented with one or more remote servers and/or storage devices. The remotes servers and/or storage devices can be located in one or more locations and are communicatively coupled with each other to collectively form a cloud. A cloud can be a private cloud or public cloud. A public cloud is distinguishable from a private cloud by the security protection provided by the cloud. For example, a public cloud may be accessible by a large number of users and/or a large number of computing devices. Access to the public cloud may require no more than a username and/or password to authenticate a user attempting to access the public cloud. In contrast, a private cloud may be only accessible to a particular user and/or computing device. Access to the private cloud from a computing device may require an exchange of cryptographic messages using cryptographic keys stored on the particular computing device. A private cloud may implement a secure execution environment providing a level of security exceeding or equivalent to a secure element to provide secure remote storage and computing resources.

As used herein, the term “asset” may refer to a data asset or the execution of a data asset. A data asset may be data or a piece of information stored on a computing device or otherwise accessible by a computing device (e.g., through a communication channel with another device) that may require security protection. For example, a data asset may be sensitive information associated with a user, such as Personal Identifying Information (PII) (e.g., name, home address, e-mail address, phone number, social security number, etc.), Personal Account Information (PAI) associated with a financial account (e.g., primary account number (PAN), expiration date, verification numbers or codes, etc.), Personal identification Number (PIN), or a username/password associated with other types of non-financial accounts (e.g., email accounts), etc. A data asset may also be device information associated with a computing device such as Electronic Serial Number (ESN), Internet Protocol (IP) address, Media Access Control (MAC) address, device identifier, device settings, geo-location information associated with the computing device, etc. A data asset may also be user data such as a picture or image taken by a user, an audio recording, a contact of the user, etc. Data assets may also include data or information used for cryptographic operations such as cryptographic algorithms, digital certificates, cryptographic keys, etc., and/or data resulting from a cryptographic operation such as encrypted data. Thus, data assets may include information that is stored or programmed onto the computing device, specifically entered into the computing device by the user, and/or information otherwise accessible by the computing device that may be used by the computing device. An asset may also include execution of a data asset such as code that uses a data asset (e.g., software code of an application or operating system, firmware code, etc.). An asset may be associated with other assets, for example, by being mapped or linked to other assets, or by being used by the same application. For example, a PAN may be associated with a name on the account and a verification code. An asset may also be an association of multiple assets such as a cryptographic binding of multiple assets.

As used herein, a “security policy” may include a set of rules that are used for protecting and/or controlling access to an asset. For example, a security policy may determine how an asset is stored (e.g., in an encrypted form or in a certain storage area), or determine how an asset can be accessed (e.g., authentication of a requesting entity, exchange of cryptographic messages, etc.). The security policy of an asset (i.e. security policy being enforced on an asset) may be tied to the ranking of the asset and may be dependent on the value of the asset. The security policy of an asset can be set and enforced by secure components built through the chain of trust. For example, the highest privilege security policy may be enforced by a Root of Trust. As another example, a lesser privilege security policy may be enforced by an operating system.

As used herein, the “value” of an asset is a measurement of the importance and/or the sensitive nature of the asset. Depending on the type or classification of the asset, the value of an asset can be based on one or more of a monetary value associated with the asset, a number of cryptographic bindings that include the asset, and/or a number of additional assets that are associated with the asset. For example, the value of a PAN can be based on the monetary amount of the available credit or balance on the account. The value of a PAN may also be based on the number of cryptographic bindings that the PAN is part of. For example, the number of different certificates or keys bound to the PAN may provide an indication of how often the PAN was used, and the more often a PAN is used, the more valuable the PAN may be. The value of a PAN can also be based on the number of other assets associated with the PAN. For example, a standalone PAN may be less valuable that a PAN that is linked to a name on the account.

As used herein, an “execution environment” is a collection of hardware and/or software components that defines a computing configuration. The components can be locally resident on a computing device and/or be remotely located at a different location than the location of the computing device. Examples of an execution environment include secure element, trusted execution environment, operating system, software applications, public cloud, private cloud, etc. Each execution environment has certain resources available to the particular execution environment for storage and execution of assets.

As used herein, a “secure element” is an example of an execution environment. A secure element securely stores applications and/or credentials (e.g., PANs) and provide them for secure execution of applications. The secure element may include secure memory to securely store application code and data and administer the secure execution of applications. The secure element may include computing logic, such as a 8-32 bit CISC/RISC processor, a crypto processor for encrypting, decrypting and signing data packets using security algorithms such as AES, DES, ECC, a random number generator, ROM, RAM, EEPROM/Flash, a communication interface and a Memory Management unit. The secure element may also provide delimited memory for each application. A secure element can be implemented with a subscriber identity/identification module (SIM) card, a Secure Digital (SD) card, or a hardware security token embedded in a computing device.

A “subscriber identity/identification module” (SIM) can is commonly used to securely store the international mobile subscriber identity (IMSI) and the related keys used to identify and authenticate subscribers on mobile devices. A SIM circuit is embedded into a removable plastic card. This plastic card is called “SIM card” and can be transferred between different mobile devices. A SIM card is an example of a SE implementation, however, other variations of a SIM card, such as a universal integrate circuit card (UICC) may be interchangeably used herein, without departing from the scope of the invention.

As used herein, a “trusted execution environment” (TEE) may be another example of an execution environment. A trusted execution environment may be supported in software, hardware, firmware or a combination thereof. The trusted execution environment may be implemented so that its execution and data space are isolated from other environments executing code on the computing device. For example, the trusted execution environment may have dedicated or protected processing and system resources, such as secure storage and protected memory buffers. In some implementations, a trusted execution environment may have paging structures, exception handlers, protected memory regions and hardware resources dedicated or associated with the trusted execution environment.

“Virtualization” may be used for providing isolation between different operating environments sharing the same physical resources, and can be one form of TEE. In other words, virtualization provides a logical abstraction of computing resources from physical constraints. One common abstraction is referred to as a virtual machine (VM), which provides the content running in the VM a direct interface to the physical hardware while maintaining the abstraction. Virtualization technology allows multiple VMs running on the same physical hardware to operate independently and isolated from each other. One or more VMs on the system can be managed by a Virtualized Machine Monitor, or VMM (also known as hypervisor or host). The VMM is a software or firmware layer component responsible for hosting and managing virtual machines. The VMM manages the system's processor, memory, and allocates other resources for each VM.

An “operating system” (OS) is another example of an execution environment and may be a collection of software that manages computer hardware resources and provides common services for applications. The operating system is a vital component of the system software in a computing device. Software applications usually require an operating system to function. The operating system may determine which software application is given access to which resource on the computing device.

A “cryptographic operation” may include encryption, decryption, Message Authentication Code generation or verification, hash generation or verification (e.g., SHA-1 (Secure Hash Algorithm-1) and SHA-256 (Secure Hash Algorithm-256), etc.). A cryptographic operation may be used to change a representation of an asset. A cryptographic operation can be performed on data or a sequence of bits resulting in a cryptographic string.

A “Root of trust” (RoT) can be a combination of one or more of hardware, firmware, and/or software components for performing security-critical functions, such as migrating assets to different execution environments and enforcing security policies against assets. The root of trust is ideally implemented in hardware or protected by hardware and is inherently trusted. In exemplary implementations, option ROMs or secure fuses may be used for implementing a root of trust on a device.

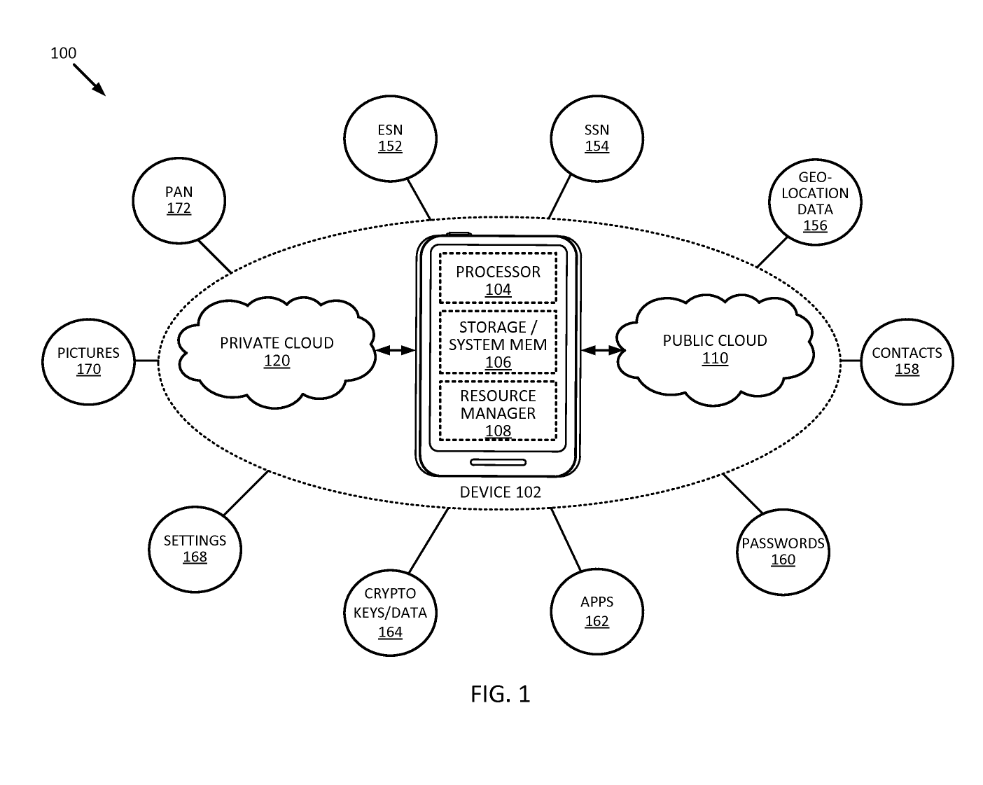

FIG. 1 illustrates an exemplary system 100 according to embodiments of the present invention. System 100 includes a computing device 102 and optional public and private clouds 110 and 120 communicatively coupled to computing device 102. Computing device 102 may include one or more processors 104 and one or more storage and/or system memories 106. The one or more storage and/or system memories 106 can be implemented with computer accessible mediums (e.g., readable and/or writable storage mediums). Embodiments of the invention for resource management may be implemented in software, firmware or/and hardware as a resource management module 108 (also referred to as a resource manager). Resource management module 108 may be a collection of mechanisms for managing resources on computing device 102, and may reside in one or multiple locations on computing device 102 and/or remotely from computing device 102 at a trusted entity. For instance, in one exemplary embodiment, the resource management on the device may be implemented as a module acting as a trusted computing base in the operating system kernel with high level of privilege and access to most of the system software, hardware and storage across the device. Resource management module 108 may work in conjunction with security hardware hooks in computing device 102, such as secure cryptographic and unique keys, encryption engines and read/write privileges for access to device resources by embodiments of the invention. Resource management module 108 may also provide a secure application interface to operate at the application layer and also to provide the user with an interface to interact with embodiments of the invention, e.g., for prioritizing the relocation of the assets. In one embodiment, the integrity and authenticity of resource management module 108 may be verified statically at boot time of computing device 102 or dynamically at run-time.

According to some embodiments, computing device 102 is a mobile device as shown (e.g., smart phones, cell phones, personal digital assistants (PDAs), laptops, notebooks, tablets, etc.). Although computing device 102 is shown as a mobile device, it should be understood that in other embodiments, computing device 102 can alternatively be a computer, a point-of-sale device, a security token device, or other types of electronic device suitable for implementing embodiments of the present invention. Computing device 102 may can be used to perform various tasks including secure tasks such as secure payment or banking transactions using assets available to computing device 102. For example, computing device 102 can be used to conduct a payment transaction using Primary Account Number (PAN) 172. Other assets that are available for use by computing device 102 to facilitate a task can include Electronic Serial Number (ESN) 152, Social Security Number (SSN) 154, geo-location data 156, contacts 158, passwords 160, software applications 162, cryptographic keys and data 164, device settings 168, pictures 170, etc. As another example, computing device 102 can be used to access an email account using one of passwords 160. It should be understood that the assets illustrated in FIG. 1 are merely examples, and that embodiments of the invention are not limited to these specific assets.

An asset need not be locally stored on computing device 102 to be made available or accessible by computing device 102. For example, one or more of the assets can be stored remotely on public cloud 110 or be securely stored remotely on private cloud 120. To access an asset to facilitate a task, computing device 102 may communicate with public or private clouds 110 and 120 to retrieve the asset or issue commands or instructions to process the asset remotely. In the case of private cloud 120, computing device may establish a secure communication channel (e.g., using Secure Shell SSH protocol, etc.) with private cloud 120 to gain access to an asset.

A. Exemplary Classification of Assets

The assets available to or accessible by computing device 102 can be classified into different types or categories of assets by resource management module 108. For example, according to some embodiments, an asset can be classified as Personal Identifying Information (PII), Personal Account Information (PAI), non-financial account information, device information, cryptographic information, software applications, and user data, etc. PII is information that can be used to identify an individual or user of computing device 102. Examples of PII may include name of a user, address, birth date, SSN 154, phone number, etc. PAI is information that can be used to identify or access a financial account. Examples of PAI may include PAN 172 or other account number, security or verification numbers/codes or resource for generating such codes (e.g., CVV2, dCVV, etc.), expiration date, routing number, PIN associated with a financial account, etc. Non-financial account information is information that can be used to identify or access a non-financial account of a user. Examples of a non-financial account may include email account, social media account, loyalty program account, etc., and non-financial account information may include username, password 160, etc. of such accounts. Device information is information that can be used to identify a computing device or other information relating to a computing device. Examples of device information may include ESN 152, IP address, MAC address, device identifier, device settings 168, device PIN, geo-location data 156, etc. Cryptographic information is data or information that is used for performing cryptographic operations, or data or information resulting from the cryptographic operations. Examples of cryptographic information may include cryptographic key 164 (e.g., public key, private key), digital certificate, digital signature, encryption/decryption algorithm, hash value, hashing algorithm, cryptographic binding, etc. Software applications are applications 162 that are preloaded, downloaded, or otherwise accessible by a computing device that can be executed on or by the computing device. Examples of applications 162 may include mobile wallet application, mapping application, email application, text messaging application, internet browser application, etc. User data is data or information that a user has specifically either inputted or downloaded onto a computing device, or specifically generated by the user through the use of the computing device. Examples of user data may include contacts 158 of the user, pictures 170 or images downloaded or taken by a camera of computing device, video recordings, etc.

Some assets may be considered as belonging to more than one type or category. For example, an email address may be considered as being both PII and non-financial account information. In such scenarios, a security policy can be used to define what type or category the particular asset will be classified as. The security policy defining how assets are classified can be set by an entity such as an issuer, a device manufacturer, a service provider (e.g., mobile network operator), or other trusted entity, and in some embodiments, can also be user configurable.

It should also be understood that the types and categories described herein are merely examples, and that in other embodiments, the classification may include other types or categories or assets, and in some embodiments, may also include sub-types or sub-categories. For example, assets in a certain classification may further include sub-types or sub-classifications for providing appropriate data protection. In some embodiments, the sub-type or sub-classification may be based on a state of the asset (at-rest, in-use or in-transit).

In some embodiments, classification of an asset can be carried out by recognizing one or more properties (e.g., characteristics, attributes, etc.) of the asset. For example, a sixteen digit number can be recognized as a PAN, in which the first six digits of the number include a valid “issuer identification number” or a “bank identification number.” For example, the issuer identification number may indicate if the issuing network is Visa®, American Express®, Master Card®, Discover®, Diners Club®, and such. In some embodiments, assets that are associated with a particular asset may also be used to facilitate the classification of the asset. For example, a sixteen digit number that is associated with an expiration date and a security or verification code may be classified as a PAN. As another example, an alphabet string with two words and associated with an address may be classified as a name. As a further example, an asset with a file extension of .jpeg can be classified as an image or picture.

B. Exemplary Valuation of Assets

An asset may have a value that can dynamically change over time. As an example, a PAN may have a value that varies over time, and the value can be based on the monetary amount available on the account of the PAN (e.g., a PAN associated with a prepaid card or a gift card). The monetary amount may be an available credit or balance on the account associated with the PAN. As a user uses the PAN to make payments (e.g., to purchase goods or services) or to obtain money from the account of the PAN, the available credit or balance on the account may decrease. As a result, the value of the PAN decreases. A user may also transfer a payment to the account of the PAN to increase the value of the PAN. Thus, the value of an asset may fluctuate over time based on the monetary amount associated with the account.

Other examples of sources of assets that may have a value determined based on a monetary amount include foreign currency exchange rates, loyalty or airline points program, social network or gaming status, products or goods for sale through the use of a computing device, etc. As the value of currency exchange rates changes over time, the value of an asset with a monetary amount may change with the exchange rate when the asset is being used in a foreign country. For example, different currencies, such as, Euros, Yen, Rupees, Peso, Pounds, Dollars, etc. are volatile and may fluctuate over time. The value of an asset may have one value in one country, and the value can change when the asset is used in a different country. The value of an asset may also be based on the loyalty points or airline points associated with the asset. Loyalty points or airline points can be redeemed to purchase products or services, and thus has a monetary value associated with them. As a user redeems the points or earn more points, the valued of the asset may fluctuate accordingly. Loyalty or airline points may also have an expiration timeline, and may lose value after that timeline has expired. The value of an asset may also be based on a monetary amount associated with a social network status or gaming status which may provide a user with virtual currency that can be traded for real or virtual products and services, or converted into real currency.

Some assets may not have a monetary amount associated with the asset. For example, a password may not have a monetary amount associated with the password. The value of such assets may be determined based on the number of additional assets that are associated or linked with the asset. For instance, a standalone password by itself may have little value. However, if the password is associated with or linked to a username, the value of the password may increase. The value of the password may further be increased by associating or linking the password to one or more applications in which the password is used for authenticating a user to a service provided by the application. As applications that use the password for authentication are removed, uninstalled, or otherwise de-associated with the password, the value of the password may decrease.

In some embodiments, the value of an asset can be determined based on a number of cryptographic bindings that include the asset. A cryptographic binding is an association between multiple assets that facilitates a cryptographic operation. For example, a data asset such as a PAN may be associated with a cryptographic key that is used to encrypt the PAN. The association between the PAN and the cryptographic key is one example of a cryptographic binding. As another example, a hash can be computed over multiple assets. The association between the multiple assets over which the hash is computed is another example of a cryptographic binding. An asset such as a cryptographic key that is used to encrypt many different assets will have a large number of cryptographic bindings, and may be more valuable than another cryptographic key that is used to encrypt just one asset. As another example, a social security number (SSN) may be cryptographically bound to a number of different cryptographic keys that are used to encrypt the SSN. The different cryptographic keys may correspond to different applications that use the SSN, and the number of cryptographic bindings of the SSN may be an indication of how many applications use the SSN. As the number of cryptographic bindings of an asset increases, the value of the asset increases.

In some embodiments, the value of an asset may be determined using a combination of the techniques describe above. For example, as discussed above, a PAN may have a monetary amount associated with the PAN. However, a standalone PAN may have little value regardless of the monetary amount, because the PAN may be useless if the PAN is not associated with other assets such as a name on the account, an expiration data, and/or a security or verification code. Thus, the number of other assets associated with or linked to an asset may increase the value of the asset. In some embodiments, the value of the associated asset may also factor into the value of an asset. For example, an asset associated with another asset that has a high value may be more valuable than an asset associated with a low-value asset. A PAN may also be cryptographically bound to a number of different cryptographic keys to indicate that the PAN is used by various applications to conduct financial transactions, and thus may be more valuable than another PAN that has less cryptographic bindings. As an example of how the value of an asset is determined using a combination of the techniques, a numeric score can be used to indicate the monetary amount associated with the asset, and the numeric score can be scaled based on the number of other assets associated with the asset, the respective values of the associated assets, and/or the number of cryptographic bindings that include the asset. The resulting scaled score may represent the value of an asset.

In some embodiments, the value of an asset can also be determined based on the state of the asset (e.g., at-rest, in-use, or in-transit). For example, an asset in-use (i.e. currently being used to facilitate a task performed by a computing device) may have a higher value than the same asset when the asset is at-rest or idle (i.e. currently not being used by computing device). An asset at-rest or idle may have a higher value than the same asset that is in-transit (i.e. the value of which is in the process of being changed), because the eventual value of the asset is not yet known.

According to some embodiments, the particular valuation technique used by resource management module 108 to determine the value of an asset can be based on and tied to the classification of the asset. For example, the value of a PAI may be determined using a monetary amount associated with the asset. The value of a piece of cryptographic information may be determined using the number of cryptographic bindings that include the cryptographic information. A security policy can be used to enforce which valuation technique is used to determine the value for assets belonging to a particular classification.

C. Exemplary Ranking of Assets

An asset with a high value associated with the asset can be mapped onto an execution environment with a more robust security profile than an asset with a lower value, such that the proper protection for the high value asset is put in place. As the value of an asset dynamically changes over time, the asset can be remapped from one execution environment to another execution environment that has the appropriate security profile to protect the asset based on the updated value of the asset. In some embodiments, the execution environment appropriate for the current value of an asset can be determined based on a ranking of the asset. Examples of how an asset is ranked include comparing the value of the asset against a set of temporal thresholds, sorting the value of the asset against the values of other assets, etc.

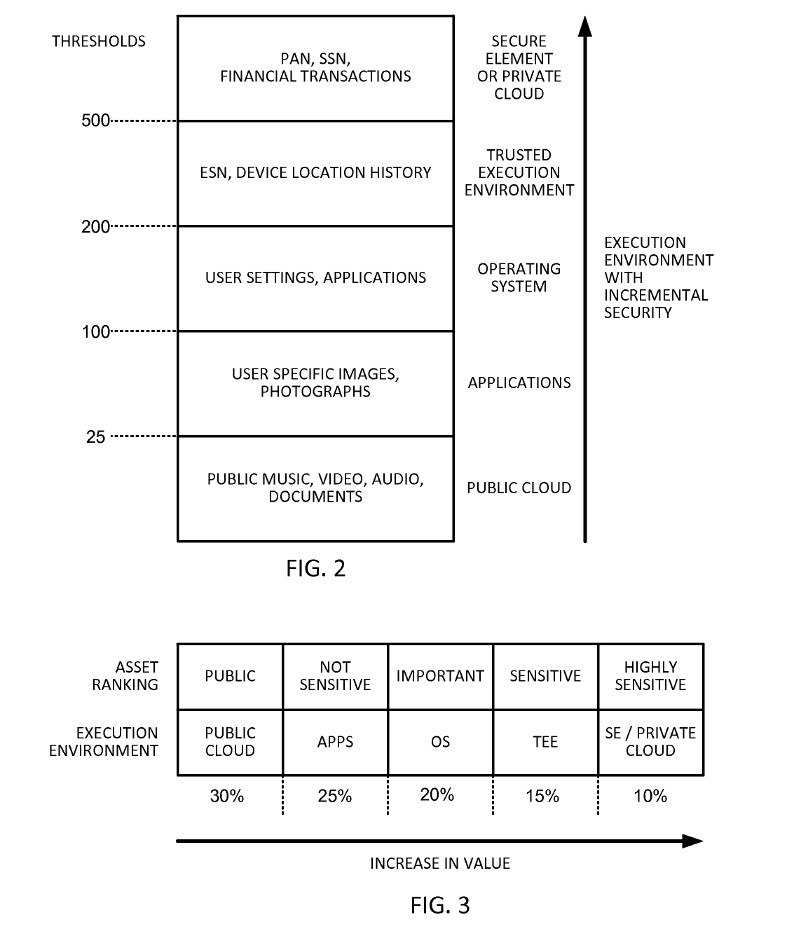

FIG. 2 illustrates an exemplary mapping of assets to different execution environments available to a computing device based on the ranking of the assets, according to some embodiments. A computing device may have a number of different execution environments available to the computing device, each with a different set of security profile to provide different levels of protection for the assets mapped to the environment. In the order of increasing security protection, the execution environments may include a public cloud, a software application environment, an operating system environment, a trusted execution environment, and a secure element or private cloud.

In some embodiments, the values of assets are determined using any of the techniques described herein. The assets are ranked by comparing the values to a set of temporal thresholds, and the assets are mapped to the appropriate execution environment. The value of an asset can be represented as a numeric score, and a higher score represents a higher value. In the embodiment as shown, the value of an asset can be compared against the thresholds of 25, 100, 200, and 500. An asset with a value having a score of 25 or less is mapped to the public cloud. An asset with a value having a score between 25 and inclusive of 100 is mapped to the software applications environment. An asset with a value having a score between 100 and inclusive of 200 is mapped to the operating system environment. An asset with a value having a score between 200 and inclusive of 500 is mapped to a trusted execution environment. An asset with a value having a score of 500 or higher is mapped to the secure element or private cloud. In other embodiments, the value of an asset can be represented as a dollar amount, or other suitable representation.

The security profile of the pubic cloud may offer minimal protection, and may be suitable for public assets such as public user data (e.g., user downloaded public music, audio, video, and documents), etc. In the embodiment as shown in FIG. 2, the value of these assets may have a score of 25 or less. The security profile of the public cloud may offer minimal protection, because the general public may be allowed to communicate with public cloud to attempt access to assets mapped to the public cloud.

Access to specific assets may require little or no authentication of the user. For example, access to specific assets may require no more than simple authentication such as a username and password, and there may be no requirement to encrypt assets mapped to the public cloud. Thus, assets mapped to the public cloud may have a high risk of being accessed by an unauthorized party. Because the public cloud is remote to the computing device, assets mapped to the public cloud may also have a high risk of being corrupted or deleted inadvertently. Nevertheless, because the public cloud is remote, management of assets mapped to the public cloud may require only a minimal amount of computing resources of a computing device, and thus mapping assets to the public cloud may free up the other resources available to the computing device such that the other resources can be used to protect higher value assets.

The security profile of the software applications environment on a computing device may offer higher security protection than the public cloud, and may be suitable for assets such as private user data (e.g., user specific images, photographs), etc. In the embodiment as shown in FIG. 2, the value of these assets may have a score between 25 and inclusive of 100. Because the assets are mapped locally to the computing device, access to the assets are limited to the computing device and other devices that have established a communication channel with the computing device. Thus, the general public would not have access to assets mapped to the software applications environment. In some embodiments, there may be no requirement to encrypt assets mapped to the software applications environment.

The security profile of the operating system environment may offer higher security protection than both the public cloud environment and the software applications environment, and may be suitable for assets such as user settings and applications, etc. In the embodiment as shown in FIG. 2, the value of these assets may have a score between 100 and inclusive of 200. Access to assets mapped to the operating system environment may require special privileges. For example, access to assets mapped to the operating system environment may require system administrator rights, and only an authenticated user and/or a subset of software applications may have such rights. There may or may not be a requirement to encrypt assets mapped to the operating system environment.

The security profile of a trusted execution environment may offer yet a higher security protection than the public cloud environment, software applications environment, and the operating system environment. The trusted execution environment may be suitable for assets such as ESN, device location history, etc. In the embodiment as shown in FIG. 2, the value of these assets may have a score between 200 and inclusive of 500. A trusted execution environment may be implemented so that its execution and data space are isolated from other environments executing code on the computing device. For example, the trusted execution environment may have dedicated or protected processing and system resources, such as secure storage and protected memory buffers. In some implementations, a trusted execution environment may have paging structures, exception handlers, protected memory regions and hardware resources dedicated or associated with the trusted execution environment. Thus, access to assets mapped to the trusted execution environment may be limited to applications running within the trusted execution environment to reduce the risk that other applications may tamper with the assets mapped to the trusted execution environment. In some embodiments, assets mapped to the trusted execution environment are required to be encrypted, and access to these assets may require an exchange or cryptographic messages using keys that are only available to trusted entities. In some embodiments, the trusted execution environment can be implemented using one or more virtual machines.

The security profile of the secure element and/or the private cloud may offer the highest security protection of the available execution environments, and may be suitable for high value assets such as PAN, SSN, financial transactions, etc. In the embodiment as shown in FIG. 2, the value of these assets may have a score higher than 500. In addition to the security protections provided by a trusted execution environment described above, a secure element (either locally on computing device or on a private cloud) also provides physical isolation from the other components of the computing device, and has dedicated computing resources to perform cryptographic operations.

It should be understood that the number of execution environments and the thresholds shown in FIG. 2 are just exemplary. In other embodiments, different threshold values can be used. Furthermore, the threshold values may be temporal and may change over time. For example, if the values of all assets available to a computing device increases, using static threshold values may result in all assets being considered as high value assets. This may result in all assets being mapped to a secure element, and may exceed the capabilities and the capacity of the secure element. As such, the threshold values can be adjusted over time to account for the change in the totality of the values of the assets, such that the assets can still be distributed across the different execution environments. As another example, if the values of all assets available to a computing device decreases, using static threshold values may result in all assets being mapped to the public cloud and/or applications environment. This may cause the other execution environments to have little or no assets to protect, and would be a waste of those resources available to the computing device. Hence, adjusting the threshold values such that the assets can be distributed across the different execution environments may provide a more efficient use of the resources available to the computing device.

In some embodiments, a security policy can be used to prevent certain sensitive assets from being mapped to a low security execution environment. For example, a security policy may be used to prevent a PAN from ever being mapped to a public cloud regardless of the how low the value of the PAN becomes. Thus, in some embodiments, certain assets may have a reduced number of available execution environments to which the asset can be mapped.

Some embodiments may also have a different number of execution environments and different number of thresholds. For example, in another embodiment, the private cloud may have a security profile that is more secure than a secure element. The private cloud can be a separate execution environment, and an additional threshold can be used to define the range of values that would result in an asset being mapped to the private cloud.

It should also be understood that the mapping of the assets shown in FIG. 2 is merely exemplary, and that the mappings can change over time as the values of the assets change. Also, as new assets are detected and identified by the computing device, the new assets are analyzed and mapped to the appropriate execution environment. The value of the new asset can be determined and compared with the threshold values. The other assets available to the computing device can be re-evaluated and may be migrated from one execution environment to another execution environment with the appropriate security profile. For example, if a new asset with a user password information is detected, the password may have a high value associated with it, and may be mapped to the secure element execution environment. In this case, PAN, SSN and financial transaction assets mapped to the secure element can be re-evaluated so that some of that information may be migrated to the trusted execution environment. As another example, if a new asset with user contacts information is detected, the user contacts information may have a medium to high value associated with it. The user contacts information may be mapped to the trusted execution environment. In this case, ESN and device location history assets mapped to the trusted execution environment can be re-evaluated so that some of that information can be migrated to either OS, applications, and/or public cloud environments. Note that the migration of the assets to lower restrained execution environments in the above examples is exemplary, and in some embodiments may be configurable. For example, assets from a trusted execution environment may be migrated to any of the execution environments (SE/OS/applications/public cloud). Assets may also be migrated from a lower security execution environment to a higher security environment.

FIG. 3 illustrates another technique for mapping assets to the different execution environments available to a computing device based on the ranking of the assets, according to some embodiments. Instead of comparing the value of an asset to a set of thresholds, the value of the asset can be sorted against the values of the other assets. For example, the top 10% of assets in terms of their associated values can be ranked as highly sensitive assets and are mapped to the secure element or private cloud. The next 15% of assets in terms of their associated values can be ranked as sensitive assets and are mapped to the trusted execution environment. The next 20% of assets in terms of their associated values can be ranked as important assets and are mapped to the operating system environment. The next 25% of assets in terms of their associated values can be ranked as non-sensitive assets and are mapped to the software applications environment. The last 30% of the assets in terms of their associated values can be ranked as public assets and are mapped to the public cloud. It should be understood that these percentages are just exemplary, and that in other embodiments, other percentages can be used. Because the technique shown in FIG. 3 uses the relative percentage ranking of the assets to map the assets to the appropriate execution environment, assets will likely be distributed across all available execution environments to ensure efficient use of the available resources.

According to some embodiments, the ranking of the assets may also be dependent on the resource capacity (e.g., computing and/or storage) of the corresponding execution environment. For example, the assets can be sorted according to their respective values, and the assets can be mapped sequentially starting from the highest value asset to the secure element until the secure element reaches capacity. Assets are then mapped to the trusted execution environment starting from the next highest value asset until the trusted execution environment reaches capacity, and so on. In this manner, the full use of the resources of the higher security environments can be maintained. In some embodiments, a buffer amount of capacity can be reserved in each execution environment, for example, to provide capacity for any new assets that may be discovered.

D. Exemplary Migration of Assets to Different Execution Environments

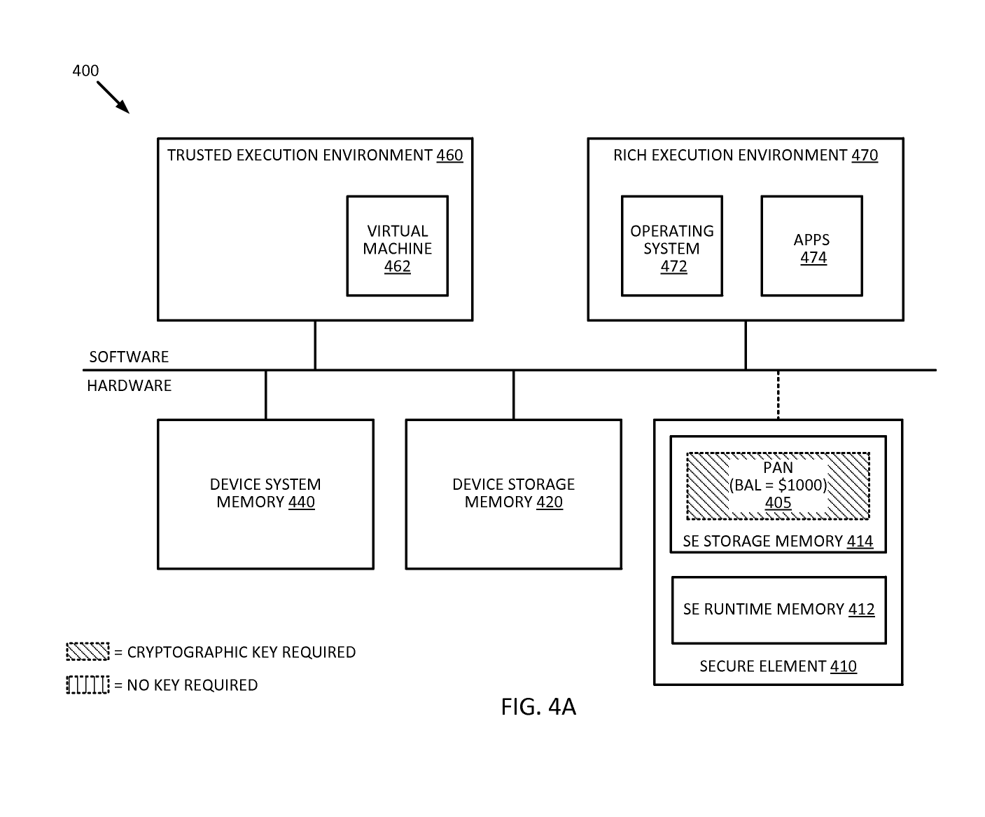

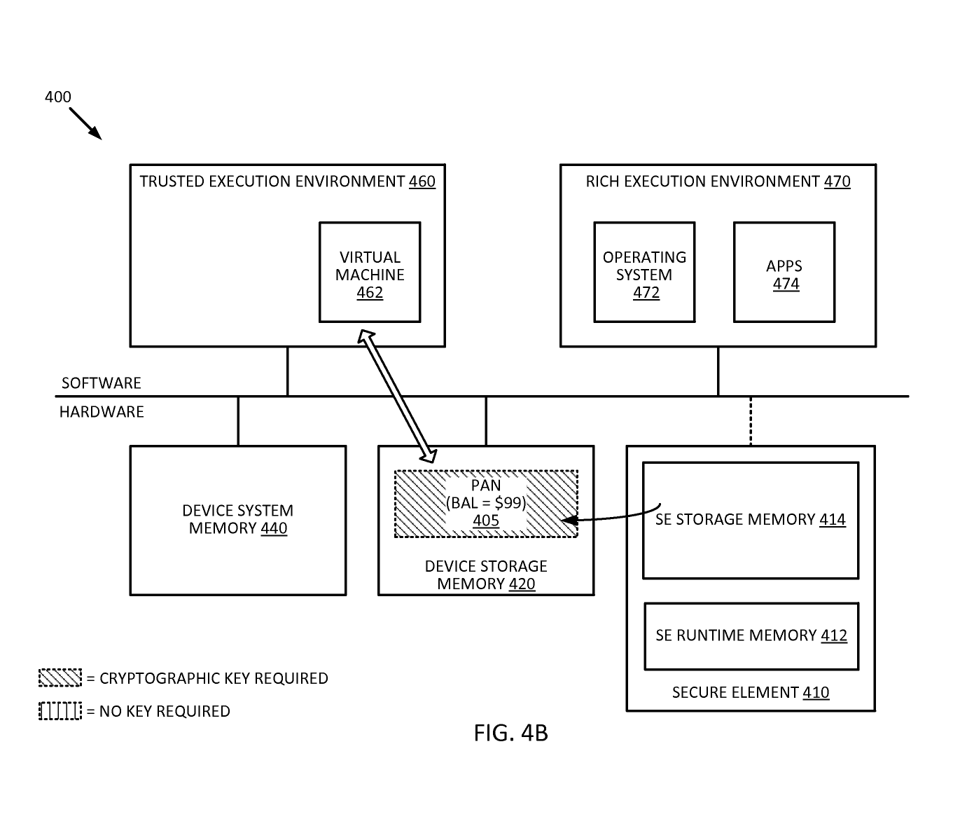

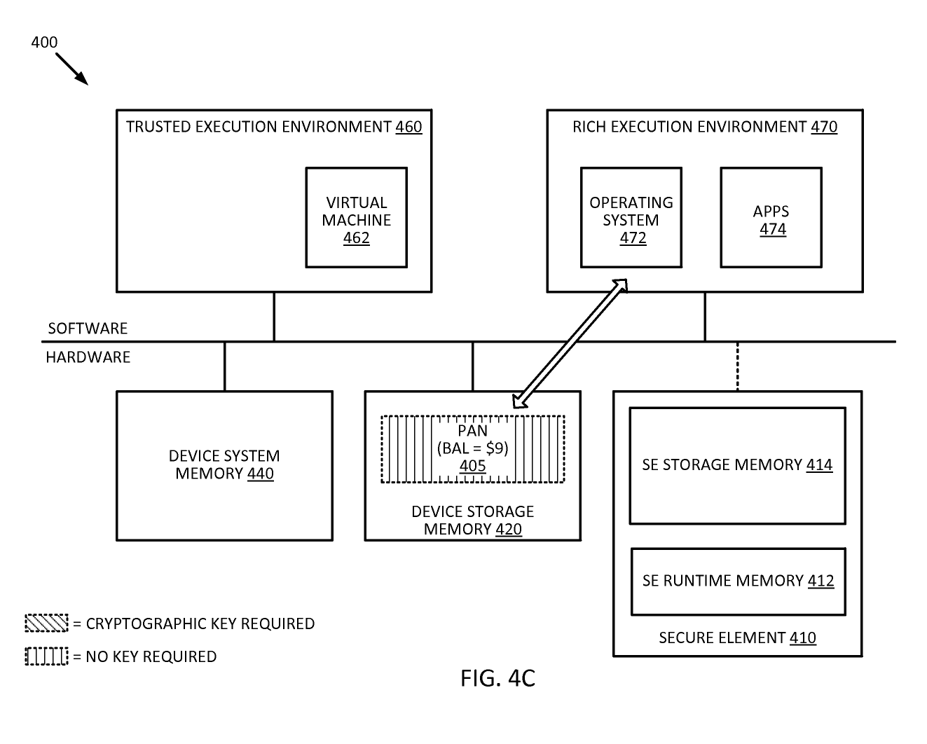

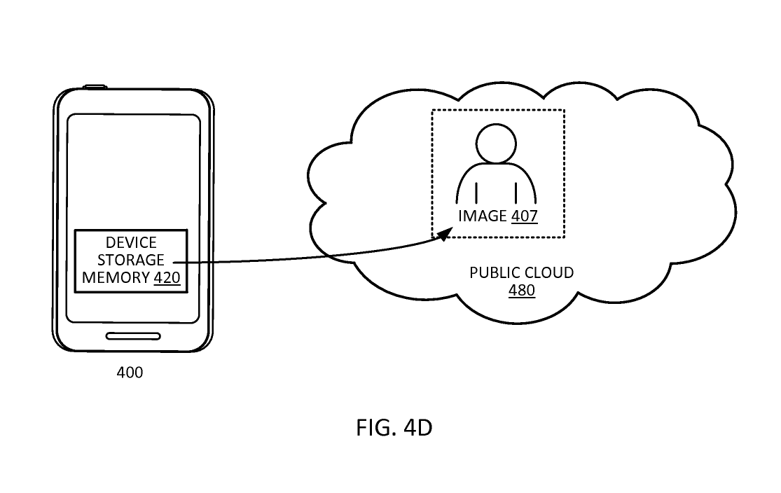

FIGS. 4A-D illustrate examples of the migration of an asset to different execution environments, according to some embodiments. FIG. 4A illustrates a block diagram of a computing device 400. Computing device 400 may have various software and hardware components implementing various execution environments available to computing device 400. For example, computing device 400 may have a hardware secure element (SE) 410 which includes SE storage memory 414 and SE system memory 412. The execution environment of SE 410 is physically isolated from the other components of computing device 400. SE storage memory 414 may be used to store highly sensitive assets. SE system memory 412 can be used as runtime memory when computing device 400 is performing a task involving the highly sensitive or high value assets stored in SE storage memory 414.

SE storage memory 414 and SE system memory 412 can be implemented as an embedded component or as a removable component such as a SIM card or a Secure Digital (SD) card, and may include a combination of various memory types, such as, volatile memory, non-volatile memory, cache, etc. Volatile memory is computer memory that requires power to maintain the stored information (e.g., SRAM, DRAM, etc.). Non-volatile memory is computer readable and/or writable memory that can retain the stored information even when not powered. Examples of non-volatile memory include read-only memory (see ROM), flash memory, etc.

Computing device 400 may also have device storage memory 420 and device system memory 440 implemented in hardware. Device storage memory 420 and device system memory 440 may be shared across the other system resources, and may be used by multiple execution environments. For example, device storage memory 420 can be used to store sensitive assets mapped to trusted execution environment 460, important assets mapped to operating system 472, and non-sensitive assets mapped to software applications environment 474. Device system memory 440 can be used by any of these environments as runtime memory when computing device 400 is performing a task involving an assets stored in device storage memory 420.

Device 400 also includes software components for implementing one or more execution environments. For example, in some embodiments, computing device 400 includes a trusted execution environment 460 and a rich execution environment 470. Trusted execution environment 460 can be implemented with one or more virtual machines 462 to provide isolation from applications running in rich execution environment 470. Rich execution environment 470 may include an operating system environment 472 and a software applications environment 474.

Computing device 400 may have access to a PAN 405. For example, PAN 405 may be inputted form a user for use in a mobile wallet application to make secure payments. As an example, PAN 405 may initially have an available balance of $1000. Because the monetary amount associated with PAN 405 is relatively high, PAN 405 may be ranked as a highly sensitive asset. As a result, PAN 405 is mapped to secure element 410. In some embodiments, PAN 405 is stored in SE storage memory 414. As a high security execution environment, secure element 410 requires assets that are mapped to secure element 410 to be stored in an encrypted format. As a result, access to PAN 405 stored in SE storage memory 414 may require a proper cryptographic key to decrypt PAN 405 before it can be used, and the cryptographic key may be only available to applications running from secure element 410.

Referring now to FIG. 4B, as the user uses PAN 405 to conduct payment transactions, the value of PAN 405 may decrease. For example, when the monetary amount associated with PAN 405 drops below $100 (e.g., $99 as shown), PAN 405 may be deprecated from a highly sensitive asset to a sensitive asset. As a result, PAN 405 may be migrated from secure element 410 to a trusted execution environment 460. Migrating PAN 405 to trusted execution environment 460 may involve exporting PAN 405 from a first storage area to a second storage area, for example, from SE storage memory 414 to device storage memory 420. In some embodiments, trusted execution environment 460 may not have access to the same cryptographic key that was used by secure element 410, but may instead have a security profile that uses a different cryptographic key to protect assets mapped to trusted execution environment 460. As a result, migrating PAN 405 to trusted execution environment 460 may also involve modifying the representation of PAN 405 to conform PAN 405 to the security profile of trusted execution environment 460. For example, PAN 405 may be decrypted by secure element 410 first, and then re-encrypted by trusted execution environment 460 using the appropriate cryptographic key available to trusted execution environment 460. Although PAN 405 is now stored in device storage memory 420, which is shared by trusted execution environment 460 and rich execution environment 470, rich execution environment 470 may not have the requisite cryptographic key that is necessary to access PAN 405. Thus, applications running in rich execution environment 470 do not have access to PAN 405 while PAN is mapped to trusted execution environment 460.

Referring now to FIG. 4C, as the user uses PAN 405 to conduct further payment transactions, the value of PAN 405 may drop below $10 (e.g., $9 as shown), and PAN 405 may be deprecated from a sensitive asset to an important asset. As a result, PAN 405 may be migrated from a trusted execution environment 460 to operating system environment 472. In some embodiments, operating system environment 472 may not have access to the cryptographic key used by trusted execution environment 460. Furthermore, the security profile of operating system environment 472 may not require assets to be stored in an encrypted format. As a result, migrating PAN 405 to operating system environment 472 may involve modifying the representation of PAN 405 to conform PAN 405 to the security profile of operating system environment 472. For example, PAN 405 may be decrypted by secure element 410 and stored in device storage memory 420 unencrypted. As device storage memory 420 is shared between trusted execution environment 460 and operating system environment 472, migrating PAN 405 to operating system environment 472 can be performed without changing the storage location of PAN 405. However, as device storage memory 420 is also shared with software applications environment 474, the migration may involve modifying a security policy of PAN 405 (i.e. a security policy enforced against PAN 405) to prevent resources in software applications environment 474 from being able to access the unencrypted PAN 405. For example, the access control of the security policy of PAN 405 may be modified such that only operating system resources can have read/write privileges for the memory location of PAN 405.

When the value of PAN 405 drops further such that PAN 405 is deprecated to a non-sensitive asset, Pan 405 may be migrated from operating system environment 472 to software applications environment 474. This can be done by modify the security policy of PAN 405 without changing the storage location of PAN 405, for example, by granting read/write privileges for the memory location of PAN 405 to the resources of software applications environment 474.

FIG. 4D illustrates an exemplary migration of an asset from computing device 400 to public cloud 480. When PAN 405 is migrated to software applications environment 474, the other assets available to computing device 400 may be re-evaluated and remapped to a different execution environment. For example, as shown in FIG. 4D, a user image previously stored in device storage memory 420 and mapped to software applications environment 474 may be deprecated from a non-sensitive asset to a public asset to free up resources in software applications environment 474 for PAN 405. As a result, user image 407 may be exported from device storage memory 420 to public cloud 480.

Although the examples illustrated in FIGS. 4A-D show the migration of an asset from a higher security environment to a lower security environment, it should be understood that an asset can also migrate from a lower security environment to a higher security environment. When an asset is migrated from one execution environment to another execution environment, the migration may involve one or more of modifying a storage location of the asset, modifying a representation of the asset, and/or modifying a security policy of the asset (e.g., access control, encryption requirement, etc.). In some embodiments, modifying the security policy of the asset can be performed without changing the storage location or the representation of the asset. According to some embodiments, migrating an asset to different execution environments may include asset anonymization/de-anonymization and/or tokenization/de-tokenization. For example, a highly sensitive asset can be anonymized by removing unnecessary sensitive data entries and tokenized using a token or known encryption key so that the asset can be migrated to an execution environments with less robust security profile as the value of the asset decreases. The reversed can be performed as the value of the asset increases. In some embodiments, migrating an asset may also include setting or resetting cryptographic keys and/or issuing or reissuing digital certificates.

According to some embodiments, each execution environment may have a set of one or more cryptographic keys mapped specifically to the execution environment forming a cryptographic key hierarchy. As an asset is migrated to different execution environments, an appropriate cryptographic key mapped to the execution environment may be used to change the representation of the asset.

In some embodiments, a task being performed by the computing device may use more than one asset, and the assets may be mapped to different execution environments. In such a scenario, the execution environment with the higher security protection will prevail. For example, when a payment transaction is conducted using a PAN and a piece of user contact information (e.g., as a recipient of the payment), the PAN may be mapped to a secure element, while the user contact information may be mapped to the software applications execution environment. In some embodiments, because the execution environment of the PAN has high security protection, the user contact information can be temporarily be migrated to the secure element for execution of the payment transaction. In some embodiments, an association can be form between the user contact information and the PAN, which may increase the value of the user contact information such that the user contact information would be mapped to the secure element beyond just the execution of the payment transaction. In either case, the payment transaction is executed from the higher security environment.

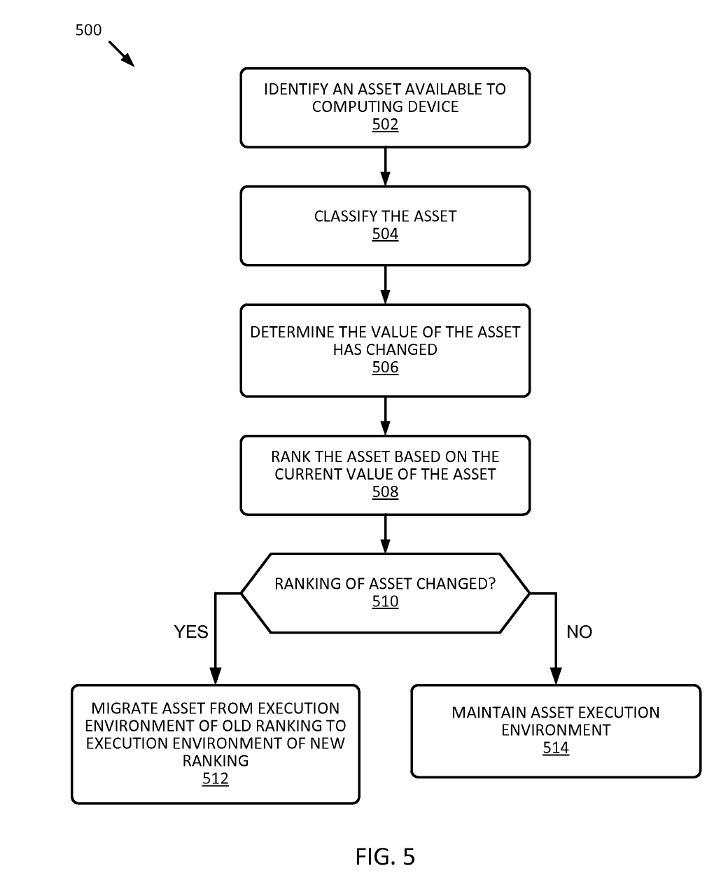

FIG. 5 illustrates a flow diagram of a method 500 for resource management of a computing device, according to some embodiments. The computing device can be, for example, a computer, a mobile device, a point-of-sale device, a security token device, or other suitable electronic device, etc. Method 500 can be performed, for example, by a resource management module implemented in the computing device or implemented remotely at a trusted entity or a combination of both.

At block 502, an asset that is available for use by the computing device is identified. In some embodiments, identification of an asset, also referred to as discovery of an asset, can be performed when the device is powered up or booted up, when an application is executed, when an asset is accessed, when a new asset is added, at a predetermined time interval according to an automatic scheduler, or when triggered by a request from a user. For example, the resource management module may read/scan the various storage devices available to the computing device for privacy and security sensitive data. The discovery or identification of assets may occur upon enabling of the resource management module on the computing device, or triggered by a request by the user or an automatic scheduler. The assets may be discovered when a secure execution is performed, such as a financial transaction. The assets may also be discovered as the various entities interact with the various assets on the computing device. For instance, as applications interact with the user and acquire and store more information on the computing device, the data associated with the transactions may be discovered as assets.

At block 504, the identified asset is classified based on one or more properties (e.g., characteristics, attributes, etc.) of the asset. Examples of various characteristics or properties of the asset include, but are not limited to confidentiality, integrity, authenticity, length, size, and/or file type of the asset. Assets may be classified based on the type of data, the type of transaction, the type of location access, the association with a security or privacy intensive application or any other suitable means. Assets may also be classified based on financial transactions, decryption of sensitive information, and verification of digital certificates and so on. The asset may be classified into various data types such as PAN, ESN, SSN, device location history, contacts, passwords, application/application data, user settings, user specific images or photographs and public generated and uploaded audio, video content and documents, etc.

At block 506, the resource management module may determine or monitor the value of the asset using the techniques described herein, and determine or detect that the value of the asset has changed. The particular valuation technique can be tied to the particular classification of the asset, and the value of the asset may be based on a monetary amount associated with the asset, the number and/or value of one or more additional assets that are associated with the asset, and/or the number of cryptographic bindings that include the asset, etc.

At block 508, the asset is ranked based on the value of the asset. The value of an asset can be ranked by comparing the value of the asset against a set of dynamic thresholds, or by sorting the value of the asset against the values of other assets to determine the relative worth or importance of the asset. In some embodiments, the asset can be ranked as highly sensitive, sensitive, important, not-sensitive or public, and each ranking can be mapped to a different execution environment. In other embodiments, other rankings can be used.

At block 510, the resource management module may determine whether the ranking of the asset has changed. For example, if the value of an asset drops below or rises above a threshold, the ranking of the asset may have changed. As another example, if the change in the value of the asset causes the asset to become more valuable or less valuable than other assets, the ranking of the asset may have changed.

At block 512, if the change in the value of the asset resulted in a change in the ranking of the asset, then in response to detecting the change in the value of the asset, the asset is dynamically migrated from the execution environment correspond to the old ranking to the execution environment correspond to the new ranking. By migrating an asset to a new execution environment, it is meant that the tasks performed by a computing device involving the asset will be execute from the new execution environment. In some embodiments, migrating an asset in response to detecting a change in the value/ranking of the asset may involve modifying a representation of the asset, and/or modifying a security policy of the asset (i.e. security policy being enforced against the asset such as access control, storage format, etc.). Migrating an asset in response to detecting a change in the value/ranking of the asset may or may not involve exporting the asset to a different storage area. Thus, some migrations may be performed without changing the storage location of the asset. The modifications performed on an asset when migrating the asset from one execution environment to another execution environment may depend on the modifications necessary to conform the asset to the new execution environment.

At block 514, if the change in the value of the asset did not result in a change in the ranking of the asset, the asset is maintained in its current execution environment.

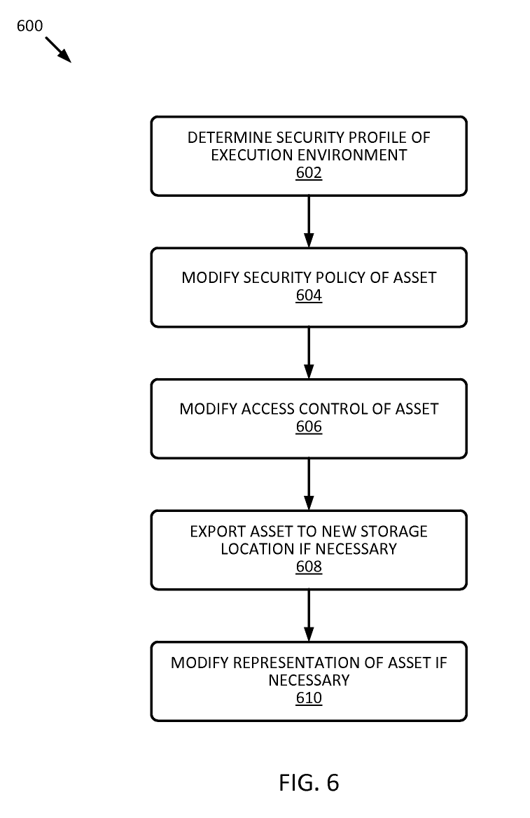

FIG. 6 illustrates a flow diagram of a method 600 for migrating an asset to a new execution environment, according to some embodiments. The method 600 can be performed, for example, by a resource management module. At block 602, the security profile of the new execution environment is determined. The security profile may describe how assets are protected in the execution environment and what privileges or permissions are required to access assets mapped to the execution environment. The security profile may define where the assets are stored and/or how the assets are stored or represented.

At block 604, the security policy of the asset (i.e. security policy enforced against the asset) is modified to conform the security policy to the security profile of the new execution environment. For example, as an asset is deprecated from a high security execution environment to a lower security execution environment, the security policy enforced against the asset may be changed from a more robust protection that may require more computing resources, to a less robust protection that may require less computing resources to conform the asset to the new execution environment. As an asset is being migrated from a low security execution environment to a higher security execution environment, the security policy enforced against the asset may be changed from a less robust protection that may require less computing resources, to a more robust protection that may require more computing resources to conform the asset to the new execution environment.

At block 606, the access control of the asset is modified to conform the asset to the new execution environment. The access control of the asset may determine what processes or entities can access the asset and how the asset is accessed. For example, the access control of an asset may prevent applications running in other execution environments from accessing the asset, or may limit the type of access to only reads such that applications running in other execution environments cannot modify the asset. The access control of the asset may also determine what type of authentication is needed to access the asset. For example, the access control of an asset may require an exchange of cryptographic messages using keys only available to an authorized entity.

At block 608, the asset is exported to a new storage location, if necessary, to conform the asset to the new execution environment. For example, if the asset was previously stored in a secure memory, the asset may be exported to an unsecure memory, or vice versa. The asset may also be exported from one region of a memory to a dedicated region of the same memory reserved for the new execution environment.

At block 610, the representation of the asset is modified, if necessary, to conform the asset to the new execution environment. For example, if the new execution environment requires the asset to be stored in an encrypted form, the asset can be encrypted accordingly. As another example, the asset can also be decrypted and re-encrypted using a different cryptographic key that is used by the new execution environment. According to some embodiments, different execution environments may have a set of one or more cryptographic keys mapped specifically to the execution environment forming a cryptographic key hierarchy. As an asset is migrated to different execution environments, an appropriate cryptographic key mapped to the execution environment may be used to change the representation of the asset. In some embodiments, the representation of the asset may also include attaching or deleting certificates

As described herein, embodiments of the present invention dynamically rank the assets and relocate them to appropriate execution environments in order to efficiently use the available resources to a computing device. For example, by migrating an asset out of the secure element execution environment to a less restrained security environment, resources on the secure element can be freed up for mapping higher value assets. Similarly, by migrating an asset from a trusted execution environment to a less restrained security environment, other more sensitive assets may be mapped to the trusted execution environment. Hence, offloading the workload to appropriate execution environment provides an efficient resource management of a computing device without being limited to the computing power or the capacity of the computing device.

It should be appreciated that the specific steps illustrated in FIGS. 5-6 provide examples of processes performed according to some embodiments of the present invention. Other sequences of steps may also be performed accordingly in alternative embodiments. For example, alternative embodiments of the present invention may perform the steps shown in FIGS. 5-6 in a different order. Moreover, the individual steps illustrated in FIGS. 5-6 may include multiple sub-steps that may be performed in various sequences as appropriate to the individual step. Furthermore, additional steps may be added or removed depending on the particular embodiments. One of ordinary skill in the art would recognize and appreciate many variations, modifications, and alternatives of these processes.

E. Exemplary Devices and Systems

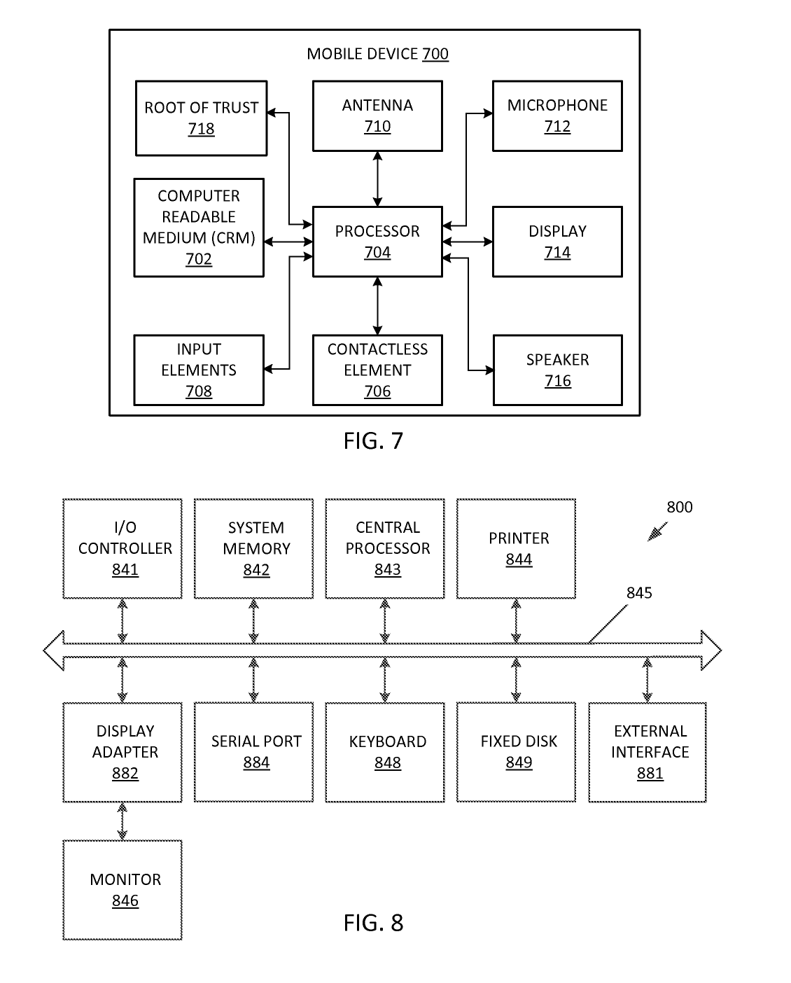

FIG. 7 illustrates at least some of the elements of an exemplary mobile device 700 in accordance with some embodiments. Mobile device 700 may be a mobile phone, a tablet, a PDA, a laptop or any such electronic device capable of communicating and transferring data or control instructions via a wireless network (e.g., cellular network, internet, etc.) and short range communications. Mobile device 700 may include the processor 704 (e.g., a microprocessor) for processing the functions of mobile device 700 (e.g., a phone) and a display 914 to allow a user to see messages (e.g., alert messages), phone numbers, images, and other information. Mobile device 700 may further include input elements 908 to allow the user to input information into the device (e.g., using a keypad, touch screen, mouse, etc.), a speaker 716 to allow the user hear voice communication, music, etc., and a microphone 712 to allow the user transmit voice through the device. Mobile device 700 may also include an antenna 702 for wireless data transfer.

In some embodiments, mobile device 700 may allow the user to communicate with one or more entities. Mobile device 700 may act as a payment device that may be used to make payments, conduct a transaction, a communication device to allow a user to log on to a website and download an application, etc. Mobile device 700 may also allow the user to download and install security sensitive applications on the mobile device 700. The exemplary mobile device 700 may comprise a computer accessible medium 702 comprising code executable by the processor 704 for implementing methods and processes using embodiments of the invention. The computer accessible medium 702 may be in the form of a memory that stores data and could be internal to the device or hosted remotely (i.e., cloud) and accessed wirelessly by the device. A contactless element 706 may be capable of transmitting and receiving wireless data or instructions using a short range wireless communications capability.

FIG. 8 is a high level block diagram of a computer system that may be used to implement any of the entities or components described herein. The subsystems shown in FIG. 8 are interconnected via a system bus 845. Additional subsystems may include a printer 844, keyboard 848, fixed disk 849, and monitor 846, which is coupled to display adapter 882. Peripherals and input/output (I/O) devices, which couple to I/O controller 841, can be connected to the computer system by any number of means known in the art, such as a serial port. For example, serial port 884 or external interface 881 can be used to connect the computer apparatus to a wide area network such as the Internet, a mouse input device, or a scanner. The interconnection via system bus 845 allows the central processor 843 to communicate with each subsystem and to control the execution of instructions from system memory 842 or the fixed disk 849, as well as the exchange of information between subsystems. The system memory 842 and/or the fixed disk 849 may embody a computer accessible medium.

As described, the techniques provided herein may involve implementing one or more functions, processes, operations or method steps. In some embodiments, the functions, processes, operations or method steps may be implemented as a result of the execution of a set of instructions or software code by a suitably-programmed computing device, microprocessor, data processor, or the like. The set of instructions or software code may be stored in a memory or other form of data storage element which is accessed by the computing device, microprocessor, etc. In other embodiments, the functions, processes, operations or method steps may be implemented by firmware or a dedicated processor, integrated circuit, etc.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions, or commands on a computer accessible medium, such as a random access memory (RAM), a read-only memory (ROM), a magnetic medium such as a hard-drive or a floppy disk, or an optical medium such as a CD-ROM. Any such computer accessible medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

As used herein, the use of “a”, “an” or “the” is intended to mean “at least one”, unless specifically indicated to the contrary.

What is claimed is:

1. A method for managing resources on a computing device, the method comprising:
identifying, by the computing device, an asset that is available for use by the computing device;
classifying the asset based on one or more properties of the asset;
determining a value of the asset has changed;
ranking the asset based on the value of the asset;
dynamically migrating the asset from a first execution environment to a second execution environment based on the ranking.

2. The method of claim 1, wherein the value of the asset is determined based on a monetary amount associated with the asset.

3. The method of claim 1, wherein the value of the asset is determined based on one or more additional assets that are associated with the asset.

4. The method of claim 1, wherein the value of the asset is determined based on a number of cryptographic bindings that include the asset.

5. The method of claim 1, wherein migrating the asset includes exporting the asset from a first storage area to a second storage area.

6. The method of claim 1, wherein migrating the asset includes modifying a representation of the asset to conform the asset to a security profile of the second execution environment.

7. The method of claim 1, wherein migrating the asset includes modifying a security policy of the asset.

8. The method of claim 1, wherein migrating the asset is performed without changing the storage location of the asset.

9. The method of claim 1, wherein ranking the asset includes comparing the value of the asset against a set of temporal thresholds.

10. The method of claim 1, wherein ranking the asset includes sorting the value of the asset against the values of other assets.

11. The method of claim 1, wherein identifying the asset is performed when the device is powered up, when the application is executed, when the asset is accessed, when a new asset is added, or at a predetermined time interval.

12. A computing device comprising:
one or more processors; and
one or more computer accessible memories coupled to the one or more processors and used for implementing:
a plurality of execution environments; and
a resource manager that determines a value of an asset accessible by the computing device based on a classification of the asset, monitors the value of the asset, and dynamically migrates the asset from a first execution environment to a second execution environment in response to detecting a change in the value of the asset.

13. The computing device of claim 12, wherein the value of the asset is determined based on one or more of:
a monetary value associated with the asset;
one or more additional assets that are associated with the asset; or
a number of cryptographic bindings that include the asset.

14. The computing device of claim 12, wherein the resource manager exports the asset from a first storage area to a second storage area in response to detecting the change in the value of the asset.

15. The computing device of claim 12, wherein the resource manager modifies a representation of the asset in response to detecting the change in the value of the asset.

16. The computing device of claim 12, wherein the resource manager modifies a security policy of the asset in response to detecting the change in the value of the asset.

17. The computing device of claim 16, wherein the security policy of the asset is modified without changing the storage location of the asset.

18. The computing device of claim 12, wherein the resource manager determines the value of the asset when the device boots up, when an application is executed, when the asset is accessed, when a new asset is added, or at a predetermined time interval.

19. A system comprising:
the computing device of claim 12; and
a public cloud coupled to the computing device and implementing one of the execution environments available to the computing device.

20. The system of claim 19, further comprising a private cloud coupled to the computing device and implementing another one of the execution environments available to the computing device, wherein the private cloud includes a remote execution environment providing security protection equivalent to or exceeding a secure element.
